(19) United States
(12) Patent Application Publication
(10) Pub. No.: US 2007/0244011 A1
(43) Pub. Date: Oct. 18, 2007

(54) Emulsifiable Concentrate Comprising a Dinitroaniline Compound

(76) Inventor: Paul Oreste Gioia, Victoria (AU)

Correspondence Address: Jean-Louis Seugnet;RHODIA Inc. - Legal Department, 8 Cedar Brook Drive, CN 7500, Cranbury, NJ, 08512-7500, US

(21) Appl. No.: 10/588,092

(22) PCT Filed: Jan. 28, 2005
(86) PCT No.: PCT/EP05/00861

§ 371 Date: May 10, 2007

Related U.S. Application Data
(60) Provisional application No. 60/540,298, filed on Jan. 30, 2004.

(51) Int. Cl. A01N 25/22; A01N 33/18

(52) U.S. Cl. 504/347

(57) ABSTRACT

The invention relates to an emulsifiable concentrate comprising an active ingredient being a dinitroaniline compound, preferably selected from the group consisting of pendimethalin, trifluralin and mixtures thereof. The emulsifiable concentrate of the invention avoids crystallization at low temperature when the concentration of the active ingredient is high. Accordingly, the emulsifiable concentrate comprises a diester co-solvent having the following formula R¹OOC—(CH₂)ₙ—COOR², wherein R¹ and R², identical or different, are C¹-C₁₀, preferably C₁-C₆, linear or branched, alkyl, aryl, alkaryl or arylalkyl groups, and n is an number of from 2 to 4.

### BACKGROUND OF THEN INVENTION

The invention relates to an emulsifiable concentrate comprising an active ingredient being a dinitroaniline compound, preferably selected from the group consisting of pendimethalin, trifluralin and mixtures thereof. The emulsifiable concentrate of the invention avoids crystallization at low temperature when the concentration of the active ingredient is high.

Emulsifiable concentrates (EC) are liquid compositions comprising an active ingredient in a liquid form, for example an active ingredient having a biological effect on plants (agricultural active). Emulsifiable concentrates usually have a single phase. Emulsifiable concentrates are to be mixed with water, in order to obtain a direct emulsion having a liquid hydrophobic phase comprising the active ingredient dispersed in water. For example a farmer would mix an emulsifiable concentrate comprising a hydrophobic agricultural active with water and readily obtain an emulsion to be applied onto a field. This procedure, where the farmer prepares from a concentrated composition the final product to be applied onto a field, is usually referred to as a “tank mix” procedure. An emulsifiable concentrate is also referred to as a “tank mix” composition.

Pendimethalin and trifluralin are herbicide compounds. Emulsifiable concentrates comprising an active ingredient selected form the group consisting of pendimethalin, trifluralin and mixtures thereof are known. For example some emulsifiable concentrates comprising 330 g/l of pendimethalin, emulsifiers, and a solvent are known. However more concentrated pendimethalin crystallizes at low temperatures, in emulsion concentrates or when mixing with water is performed. The crystallization is characterized by formation of small solid particles of pendimethalin. These small particles have the bad impact of: filters clogging, nozzles clogging, creating unnecessary hazardous waste problems to dispose off the crystals, loss of activity, and/or bad repartition of the active on the field.

The invention relates to an emulsifiable concentrate avoiding to some extent crystallization problems, at pendimethalin and/or trifluralin concentrations of up to 435 g/l or even more.

### BRIEF SUMMARY OF THE INVENTION

The emulsifiable concentrate according to the invention comprises an active ingredient being a dinitroaniline compound, preferably selected from the group consisting of pendimethalin, trifluralin and mixtures thereof, an emulsifier or an emulsifier mixture, and a solvent, wherein it comprises (further to the solvent) an amount (preferably an effective amount) of a diester co-solvent having the following formula:
R¹OOC—(CH₂)ₙ—COOR²,
wherein:
R¹ and R², identical or different, are C₁-C₁₀, preferably C₁-C₆, linear or branched, alkyl, aryl, alkaryl or arylalkyl groups, and
n is an average number of from 2 to 4.

The invention also relates to a method for preparing an emulsion of an active ingredient being a dinitroaniline compound, preferably selected from the group consisting of pendimethalin, trifluralin and mixtures-thereof in water,-comprising the step of mixing 1 part by volume of the emulsifiable concentrate, with at least 10 parts of water, preferably with at least 15 parts, for example 19 or 20 parts, by volume of water.

The invention also relates to an emulsion comprising:
an active ingredient being a dinitroaniline compound, preferably selected from the group consisting of pendimethalin, trifluralin and mixtures thereof,
an emulsifier or a mixture of emulsifiers,
a solvent,
a diester co-solvent having the following formula:
   R¹OOC—(CH₂)ₙ—COOR²,

wherein:

R¹ and R², identical or different, are C₁-C₁₀, preferably C₁-C₆, linear or branched, alkyl, aryl, alkaryl or arylalkyl groups, and

n is an average number of from 2 to 4, and
water.

The emulsifiable concentrate according to the invention avoids crystallization problems at low temperature and/or at high level of actives, in the emulsifiable concentrate itself or when mixing with water. For example it can avoid crystallization problems at below 0° C. and concentrations of up to 435 g/l, prior to mixing with water. The emulsifiable concentrate, the emulsions formed therefrom, and the emulsion according to the invention have moreover a good biological activity (selective herbicidal activity for destroying most annual grasses and many annual broad-level weeds) and/or a low toxicity.

### DETAILED DESCRIPTION OF THE INVENTION

Pendimethalin

Pendimethalin is the usual denomination of a well-known herbicide dinitroaniline compound. Pendimethalin is actually N-(ethylpropyl)-3,4-dimethyl-2,6-dinitrobenzenamine.

Trifluralin

Trifluralin is the usual denomination of a well-known herbicide dinitroaniline compound. Trifluralin is actually α,α,α-trifluoro-2,6-dinitro-N,N-dipropyl-p-toluidine.

Diester Co-Solvent

The diester solvent has the following formula:
R¹OOC—(CH₂)ₙ—COOR²,
wherein:
R¹ and R², identical or different, are C₁-C₁₀, preferably C₁-C₆, linear or branched, alkyl aryl, alkaryl or arylalkyl groups, and
n is an average number of from 2 to 4.

The diester co-solvent can be a dialkyl, diaryl, dialkaryl or dialkylaryl adipate, such as for example diisobutyl adipate.

As n is an average number, the diester co-solvent can be a mixture of several compounds having different numbers of —CH₂— groups.

The diester co-solvent can be a mixture of adipate diesters (n=4), glutarate diesters (n=3), and succinate diesters (n=2).

The diester co-solvent is preferably a mixture of diisobutyl adipate, diisobutyl glutarate, and diisobutyl succinate, for example a mixture comprising:
from 59 to 67 parts by weight of diisobutyl glutarate,
from 20 to 28 parts by weight of diisobutyl succinate, and
from 9 to 7 parts by weight of diisobutyl adipate.

Examples of useful diester co-solvents include Rhodiasolv DIB®, marketed by Rhodia. The diester co-solvents described above are considered as green solvent having a low Volatile Organic Compound behavior and/or a low toxicity.

Other interesting diester co-solvents include dimethyl adipate and mixutres of dimethyl adipate, dimethyl glutarate and dimethyl succinate.

The amount of the diester co-solvent in the emulsifiable concentrate is preferably of from 10 to 30 g/l, for example about 20 g/l.

Emulsifiers

The emulsifier or mixture of emulsifiers is preferably selected from the group consisting of the following compounds:
anionic surfactants such as alkylbezenesuflonates such as dodecylbenzenesulfonates, for example calcium dodecylbenzensulfonate, ethoxylated and/or propoxylated di- or tri-styrylphenol phosphates, ethoxylated and/or propoxylated di- or tri-styrylphenol sulfates, phenyl sulfonates, alkynaphtalenesulphonates, ethoxylated and/or propoxylated alcohol phosphate esters, ethoxylated and/or propoxylated alkylaryl phosphate esters, taurates, suphosuccinates, polycarboxylates,
nonionic surfactants such as ethoxylated and/or propoxylated di- or tri-styrylphenols, ethoxylated and/or propoxylated fatty alcohols, ethoxylated and/or propoxylated fatty amines, ethoxylated and/or propoxylated alkylphenols such as ethoxylated nonylphenols, block copolymers having polypropylene glycol blocks and polyethylene glycol blocks, sorbitan esters, Ethoxylated oleic acids, ethoxylates castor oils, and
mixtures thereof.

The emulsifier or mixture of emulsifier, and the amounts thereof, are such that an emulsifiable concentrate is obtained. This is known by the one skilled in the art of formulating the active ingredient. The emulsifiable concentrate typically comprises from 100 to 130 g/l of the emulsifier or mixture of emulsifiers.

Preferred mixtures of emulsifiers include mixtures of:
at least 50 g/l (relative to the emulsifiable concentrate), preferably from 55 g/l to 65 g/l, for example 60 g/l, an of an alkaline metal or alkaline metal salts of dodecylbenzene sulfonic acid, such as calcium dodecylbenzene sulfonate (CaDDBS), for example Rhodacal 60/BE-C marketed by Rhodia, a 60% CaDDBS solution in ethylhexanol, or Rhodacal 70 marketed by Rhodia, a 60% CaDDBS solution in isobutanol, and
at least 50 g/l (relative to the emulsifiable concentrate), preferably from 55 g/l to 65 g/l, for example 60 g/l, of alkylaryl ethylene oxide/propylene oxide block copolymers, for example Antharox 724/P marketed by Rhodia.

Other preferred mixtures of emulsifiers include mixtures of:
at least 50 g/l (relative to the emulsifiable concentrate), preferably from 54 g/l to 72 g/l, for example 66 g/l, an of an alkaline metal or alkaline metal salts of dodecylbenzene sulfonic acid, such as calcium dodecylbenzene sulfonate (CaDDBS), for example Rhodacal 60/BE-C marketed by Rhodia, a 60% CaDDBS solution in ethylhexanol, or Rhodacal 70 marketed by Rhodia, a 60% CaDDBS solution in isobutanol, and
at least 40 g/l (relative to the emulsifiable concentrate), preferably from 48 g/l to 66 g/l, for example 54 g/l, of ethoxylated and/or propoxylated di- or tri-styrylphenols, preferably ehtoxylated and propoxylated tristyrylphenols, for example Soprophor TSP/724 marketed by Rhodia.
   Solvent

The emulsifiable concentrate comprises an organic solvent. Organic solvents suitable include aromatic hydrocarbon solvents such as toluene, xylenes, polynuclear aromatic hydrocarbons such as naphthalenes and alkylnaphthalenes and mixtures thereof, many of which are available from the fractionation of crude oil and in general have distillation ranges in the temperature range of about 135° C. to 305° C., with those having a distillation range of from about 183° C. to 290° C. being most preferred. These solvents are commercially available under a variety of tradenames, e. g. SOLVESSO 200 and AROMATIC 200 both commercially available from Exxon, Fareham, Hants, United Kingdom. Organic solvent suitable also include esters of plant oils, cyclic amides and lactones.

Other compounds

The emulsifiable concentrate according to the invention might comprise further ingredients, as follows.

The emulsifiable concentrate might comprise antifoaming agents. Antifoaming agents suitable for use in the compositions of the present invention include conventional antifoaming agents, with silicone based antifoaming agents such as those sold under the Silicolapse and tradenames commercially available from Rhodia, being preferred. In a preferred embodiment of the invention, an antifoaming agent is used at a level sufficient to prevent undesirable foaming during the preparation of tank mixes using the emulsion concentrates of the present invention. Typically, less than 1% by weight of a defoamer is sufficient, with amounts of about 0.01 to about 0.1% by weight being preferred.

The emulsifiable concentrate might comprise antigelation agents such as N-methylpyrrolidone, cyclohexanone, alcohols such as ethanol and methanol, glycols such as propylene glycol and ethylene glycol. These agents might be considered as the solvent or as a part thereof.

The emulsifiable concentrate of the invention might comprise further active ingredients such as other herbicides and pesticides. It is preferred that these further actives be soluble in the emulsifiable concentrate, thereby forming an emulsifiable concentrate combo. Examples of further active ingredients that might be useful include oxyacetamides herbicides.

Process

The emulsifiable concentrate compositions of the present invention may be prepared by admixing all of the ingredients in the organic solvent. In a preferred embodiment of this invention, the compositions are prepared by a method comprising the following steps:

(a) admixing the active ingredient, for example pendimethalin in a molten form into the solvent,

(b) adding the emulsifier(s),

(c) optionally allowing cooling, and

(d) optionally filtering before packaging the emulsifiable concentrate.

A detailed preferred process comprises the following steps:
(a) admixing the organic solvent and the diester co-solvent into a mixing vessel with heating capabilities;
(b) adding a calcium dodecylbenzene sulfonate and a pre-molted alkylaryl ethylene oxide/propylene oxide (block) surfactant or an ethoxylated and/or propoxylated di- or tri-styrylphenol surfactant to the first homogenous mixture of step (a), with stirring to obtain a homogenous mixture;
(c) heating the mixture up to 50 degrees Celsius, prior adding a molten dinitroaniline, pendimethalin and/or trifluarin, whilst continue to stir the final mixture for approximately 0.5 hours;
(d) allowing the mixture to cool down to 30 degrees Celsius prior adding an anti-foam and/or gelling agent to the mixture, if this is required;
(e) final mixture (d) is then allowed to stand overnight (temperature check to be below 30 degrees Celsius) prior passing through a 10 to 15 micron filter bag;
(f) if required, adding a secondary herbicide such as an oxyacetamide herbicide, to the homogenous mixture of step (c) with stirring to obtain a third homogenous mixture; and
(g) adding phosphoric acid to the third homogenous mixture of step (c) with stirring; completing with steps (d) and (e).

The emulsifiable concentrate compositions of this invention are diluted with water and applied as dilute, aqueous emulsions to the locus where weed control is desired. Typical dilution rates are in the range of about 1 part by volume of concentrate per at least 10 parts, preferably at least 15 parts, up to 500 parts, for example 19 or 20 parts. While the compositions of this invention are effective for controlling weeds when employed alone, they may also be used in conjunction with or in combination with other biological chemicals, including other herbicides.

Performance

The emulsifiable concentrate according the invention is preferably such that the active ingredient, for example pendimethalin and/or trifluralin, does not crystallize at 0° C., preferably at −5° C., at a concentration of active ingredient of at least 330 g/l, preferably of at least 400 g/l, for example at a concentration of 435 g/l, and/or such that it does not crystallize at these temperatures upon dilution.

Crystallization tests can be performed on the emulsifiable concentrate by seeding and observing (eye observation or web 45 μm sieve residue).

Crystallization upon dilution tests can be performed on the emulsifiable concentrate by observing (eye observation or web 45 μm sieve residue).

### EXAMPLES

Concrete but non-limiting examples of the invention are presented below.

### Example 1

### Formulation According to the Invention

| INGREDIENTS | g/L |
|---|---|
| Pendimethalin tech. 95% ae | 457.88 (435 g/L of active) |
| Antarox 724/P (Rhodia) | 60.00 |
| Rhodacal 60/BE-C (Rhodia) | 60.00 |
| Rhodiasolv DIB (Rhodia) | 20.00 |
| Solvesso 200 | to Vol (472.12 g used to reach volume) |

The formulation is prepared according to the detailed process described above, with cold filtering step (e) at about 25° C.

The formulation and a comparative formulation are tested (crystallization appearing depending on time and/or temperature). The results are presented on table I below.

The comparative formulation, an emulsifiable concentrate having 330 g/l of pendimethalin, marketed by BASF as STOMP E 330.

TABLE I

| Sample | Example 1 | Comparative |
|---|---|---|
| Emulsion in 1000 | Good bloom, | Good bloom, |
| ppm Hard Water | Good emulsion → | Good emulsion → |
| | T0.5 HRS → <0.1 ml sd* | T0.5 HRS → <0.1 |
| | T24 HRS → 0.3 ml sd* | ml cr** |
| | | T24 HRS → 0.4 |
| | | ml cr** |
| 1 week at 2° C. | No crystals | — |
| 2 week at 2° C. | No crystals | No crystals |
| 2 week at 0° C. | No crystals | No crystals |
| 2 week at −2° C. | No crystals | No crystals |
| 1 week at −5° C. | No crystals | Some very fine |
| | | crystals forming |
| | | a sludge |
| 2 week at −10° C. | No crystals | Aborted (crystals) |
| 2 week at 54° C. | Physically stable | Physically stable |
| 8 week at 40° C. | Physically stable | Physically stable |
| 12 week at Room | Physically stable | Physically stable |
| Temperature | | |
| 6 months at Room | Physically stable | Physically stable |
| Temperature | | |

*sedimentation
**creaming

### Example 2

### Formulation According to the Invention

| INGREDIENTS | g/L |
|---|---|
| Pendimethalin tech. 95% ae | 457.88 (435 g/L of active) |
| Soprophor TSP 724/P (Rhodia) | 53.93 |
| Rhodacal 60/BE-C (Rhodia) | 61.91 |
| Rhodiasolv DIB (Rhodia) | 21.40 |
| Solvesso 200 | to Vol (472.83 g used to reach volume) |

The formulation is prepared according to the detailed process described above, with cold filtering step (e) at about 25° C.

1-14. (canceled)

15. An emulsifiable concentrate comprising an active ingredient being a dinitroaniline compound, an emulsifier or an emulsifier mixture, and a solvent, said concentrate comprising an amount of a diester co-solvent having the following formula:
R¹OOC—(CH₂)ₙ—COOR²,
wherein:
R¹ and R², identical or different, are C₁-C₁₀, optionally C₁-C₆, linear or branched, alkyl, aryl, alkaryl or arylalkyl groups, and
n is an average number of from 2 to 4.

16. The emulsifiable concentrate according to claim 15, wherein the active ingredient is selected from the group consisting of pendimethalin, trifluralin and mixtures thereof.

17. The emulsifiable concentrate according to claim 15, wherein the diester co-solvent is diisobutyl adipate or a mixture of diisobutyl adipate, diisobutyl glutarate, and diisobutyl succinate.

18. The emulsifiable concentrate according to claim 17, wherein the diester co-solvent comprises:
from 59 to 67 parts by weight of diisobutyl glutarate,
from 20 to 28 parts by weight of diisobutyl succinate, and
from 9 to 7 parts by weight of diisobutyl adipate.

19. The emulsifiable concentrate according to claim 15, wherein the solvent is an aromatic hydrocarbon.

20. The emulsifiable concentrate according to claim 15, comprising:
at least 330 g/l of the active ingredient, optionally from 400 g/l to 500 g/l,
from 100 to 130 g/l of the emulsifier or mixture of emulsifiers,
from 10 to 30 g/l of the diester co-solvent, and
the solvent, to volume.

21. The emulsifiable concentrate according to claim 15, wherein the emulsifier or mixture of emulsifiers is selected from the group consisting of anionic surfactants, nonionic surfactants, and mixtures thereof.

22. The emulsifiable concentrate according to claim 21, wherein the anionic surfactants are alkylbezenesuflonates, dodecylbenzenesulfonates, calcium dodecylbenzensulfonate, ethoxylated and/or propoxylated di- or tri-styrylphenol phosphates, ethoxylated and/or propoxylated di- or tri-styrylphenol sulfates, phenyl sulfonates, alkynaphtalenesulphonates, ethoxylated and/or propoxylated alcohol phosphate esters, ethoxylated and/or propoxylated alkylaryl phosphate esters, taurates, suphosuccinates, or polycarboxylates,

23. The emulsifiable concentrate according to claim 21, wherein the nonionic surfactants ethoxylated and/or propoxylated di- or tri-styrylphenols, ethoxylated and/or propoxylated fatty alcohols, ethoxylated and/or propoxylated fatty amines, ethoxylated and/or propoxylated alkylphenols such as ethoxylated nonylphenols, block copolymers having polypropylene glycol blocks and polyethylene glycol blocks, sorbitan esters, ethoxylated oleic acids, or ethoxylates castor oils.

24. The emulsifiable concentrate according to claim 21, wherein the mixture of emulsifiers comprises:
at least 50 g/l (relative to the emulsifiable concentrate), optionally from 55 g/l to 65 g/l, of an alkaline metal or alkaline metal salts of dodecylbenzene sulfonic acid, and
at least 50 g/l (relative to the emulsifiable concentrate), optionally from 55 g/l to 65 g/l, of alkylaryl ethylene oxide/propylene oxide block copolymers.

25. The emulsifiable concentrate according to claim 15, wherein the mixture of emulsifiers comprises:
at least 50 g/l (relative to the emulsifiable concentrate), optionally from 54 g/l to 72 g/l, of an alkaline metal or alkaline metal salts of dodecylbenzene sulfonic acid, and
at least 40 g/l (relative to the emulsifiable concentrate), optionally from 48 g/l to 66 g/l, for example 54 g/l, of ethoxylated and/or propoxylated di- or tri-styrylphenols.

26. The emulsifiable concentrate according to claim 15, wherein the active ingredient is pendimethalin and it does not crystallize at 0° C., optionally at −5° C.

27. A method for preparing an emulsion in water of an active ingredient being a dinitroaniline compound, optionally selected from the group consisting of pendimethalin, trifluralin and mixtures thereof, comprising the step of mixing 1 part by volume of an emulsifiable concentrate comprising an active ingredient being a dinitroaniline compound, an emulsifier or an emulsifier mixture, and a solvent, said concentrate comprising an amount of a diester co-solvent having the following formula:
R¹OOC—(CH₂)ₙ—COOR²,
wherein:
R¹ and R², identical or different, are C₁-C₁₀, optionally C₁-C₆, linear or branched, alkyl, aryl,
alkaryl or arylalkyl groups, and
n is an average number of from 2 to 4,
with at least 10 parts of water, and up to 500 parts by volume of water.

28. An emulsion comprising:
an active ingredient selected being a dinitroaniline compound,
an emulsifier or a mixture of emulsifiers,
a solvent,
a diester co-solvent having the following formula:
R¹OOC—(CH₂)ₙ—COOR²,
wherein:
R¹ and R², identical or different, are C₁-C₁₀, optionally C₁-C₆, linear or branched, alkyl, aryl, alkaryl or arylalkyl groups, and
n is an average number of from 2 to 4, and
water.

29. An emulsion according to claim 28, wherein the active ingredient is selected from the group consisting of pendimethalin, trifluralin and mixtures thereof.

30. An emulsion according to claim 29, wherein:
the solvent is an aromatic hydrocarbon,
the diester co-solvent is diisobutyl adipate or a mixture of diisobutyl adipate,
diisobutyl glutarate, and diisobutyl succinate.
